(19) United States
(12) Patent Application Publication
(10) Pub. No.: US 2011/0218294 A1
(43) Pub. Date: Sep. 8, 2011

(54) BLENDS OF POLYARYLENE ETHERS AND POLYARYLENE SULFIDES

(75) Inventors: Martin Weber, Maikammer (DE); Christian Maletzko, Altrip (DE); Susanne Zeiher, Ludwigshafen (DE); Mark Völkel, Ladenburg (DE); Norbert Güntherberg, Speyer (DE); Rüdiger Bluhm, Limburgerhof (DE)

(73) Assignee: BASF SE, Ludwigshafen (DE)

(21) Appl. No.: 13/040,593

(22) Filed: Mar. 4, 2011

Related U.S. Application Data
(60) Provisional application No. 61/310,734, filed on Mar. 5, 2010.

(51) Int. Cl. C08L 81/04

(52) U.S. Cl. 524/540

(57) ABSTRACT

The present invention relates to thermoplastic molding compositions comprising the following components:
(A) at least one polyarylene ether (A1) having an average of at most 0.1 phenolic end group per polymer chain and at least one polyarylene ether (A2) having an average of at least 1.5 phenolic end groups per polymer chain,
(B) at least one polyarylene sulfide,
(C) at least one functionalized polyarylene ether comprising carboxy groups,
(D) at least one fibrous or particulate filler, and
(E) optionally further additives and/or processing aids.

The present invention further relates to a process for producing the thermoplastic molding compositions of the invention, to the use of these for producing moldings, fibers, foams, or films, and to the resultant moldings, fibers, foams, and films.

### CROSS-REFERENCE TO RELATED APPLICATIONS

This application claims the benefit of U.S. Provisional Application 61/310,734 filed on Mar. 5, 2010, the contents of which are incorporated herein by reference in its entirety.

### FIELD OF THE INVENTION

The present invention relates to thermoplastic molding compositions comprising the following components:
(A) at least one polyarylene ether (A1) having an average of at most 0.1 phenolic end group per polymer chain and at least one polyarylene ether
(A2) having an average of at least 1.5 phenolic end groups per polymer chain,
(B) at least one polyarylene sulfide,
(C) at least one functionalized polyarylene ether comprising carboxy groups,
(D) at least one fibrous or particulate filler, and
(E) optionally further additives and/or processing aids.

The present invention further relates to a process for producing the thermoplastic molding compositions of the invention, to the use of these for producing moldings, fibers, foams, or films, and to the resultant moldings, fibers, foams, and films.

### BACKGROUND OF THE INVENTION

Polyarylene ethers are engineering thermoplastics, and the high heat resistance and high chemicals resistance of these materials leads to their use in very demanding applications. Polyarylene ethers are amorphous and therefore often have inadequate resistance to aggressive solvents. Polyarylene ethers also have high melt viscosity, and this is particularly disadvantageous for processing to give large moldings by means of injection molding. The high melt viscosity is particularly disadvantageous for producing molding compositions with high filler loading or high fiber loading.

Mixtures of high-temperature-resistant polyarylene ethers and polyarylene sulfides are known per se and, in comparison with the individual components, have by way of example improved mechanical properties and higher chemicals resistance.

EP-A 673 973 discloses glassfiber-filled polymer mixtures comprising polyarylene ether having at least 0.03% by weight of OH end groups, polyarylene ether having less than 0.03% by weight of OH end groups, and polyphenylene ulphide. The thermoplastic molding compositions of EP-A 673 973 comprise no functionalized polyarylene ether, and do not have adequate mechanical properties for all applications, in particular adequate tensile strain at break, ultimate tensile strength, and impact resistance. Resistance to fuels is particularly in need of improvement.

EP-A 855 428 discloses rubber-containing polyarylene ethers which comprise functionalized polyarylene ethers containing carboxy groups. The thermoplastic molding compositions of EP-A 855 428 comprise no OH-terminated polyarylene ethers and do not have adequate mechanical properties for all applications, in particular adequate ultimate tensile strength and impact resistance. Resistance to fuels is particularly in need of improvement.

EP-A 903 376 relates to thermoplastic molding compositions comprising polyarylene ether, polyarylene ulphide, and rubber, and these likewise also comprise functionalized polyarylene ethers. The polyarylene ethers of EP-A 903 376 have at most a small proportion of OH end groups. The functionalized polyarylene ethers used in EP-A 903 376 are often inadequate in terms of their suitability for reinforced molding compositions. The use of such products in filled, in particular fiber-reinforced, molding compositions often leads to inadequate mechanical properties, in particular to inadequate toughness and ultimate tensile strength, and also to inadequate resistance to fuels, in particular FAM B.

The prior art does not therefore disclose any strategy for improving the fuel resistance of blends of polyarylene ethers and polyarylene sulfides.

### BRIEF SUMMARY OF THE INVENTION

The object of the present invention therefore consisted in providing thermoplastic molding compositions based on polyarylene ethers, where these do not have the abovementioned disadvantages or have the same to a smaller extent. In particular, the thermoplastic molding compositions should have high resistance to fuels, in particular FAM B. At the same time, the thermoplastic molding compositions should have good mechanical properties, particularly high impact resistance, high tensile strain at break, and high ultimate tensile strength.

The abovementioned objects are achieved via the thermoplastic molding compositions of the invention. Preferred embodiments can be found in the claims and in the description below. Combinations of preferred embodiments are within the scope of the present invention.

### DETAILED DESCRIPTION OF THE PREFERRED EMBODIMENTS

The thermoplastic molding compositions of the invention comprise the following components:
(A) at least one polyarylene ether (A1) having an average of at most 0.1 phenolic end group per polymer chain and at least one polyarylene ether (A2) having an average of at least 1.5 phenolic end groups per polymer chain,
(B) at least one polyarylene sulfide,
(C) at least one functionalized polyarylene ether comprising carboxy groups,
(D) at least one fibrous or particulate filler, and
(E) optionally further additives and/or processing aids.

The thermoplastic molding compositions of the invention here preferably comprise from 20 to 88.5% by weight of component (A1), from 0.5 to 10% by weight of component (A2), from 5 to 65% by weight of component (B), from 1 to 15% by weight of component (C), from 5 to 70% by weight of component (D), and from 0 to 40% by weight of component (E), where the total of the % by weight values for components (A) to (E), based on the total amount of components (A) to (E), is 100% by weight.

The thermoplastic molding compositions of the invention particularly preferably comprise from 20 to 73% by weight of component (A1), from 1 to 10% by weight of component (A2), from 10 to 30% by weight of component (B), from 1 to 15% by weight of component (C), from 15 to 60% by weight of component (D), and from 0 to 30% by weight of component (E), where the total of the % by weight values for components (A) to (E), based on the total amount of components (A) to (E), is 100% by weight.

The individual components are explained in more detail below.

Component A

In the invention, the thermoplastic molding compositions comprise at least one polyarylene ether (A1) having an average of at most 0.1 phenolic end group per polymer chain and at least one polyarylene ether (A2) having an average of at least 1.5 phenolic end groups per polymer chain. The expression “an average” here means a numeric average.

It is obvious to the person skilled in the art that the phenolic end groups are reactive, and can be present in at least to some extent reacted form within the thermoplastic molding compositions. The thermoplastic molding compositions are preferably produced via compounding, i.e. via mixing of the components in a flowable condition. Correspondingly the wording of “thermoplastic molding compositions comprising the following components” is preferably considered equivalent to “thermoplastic molding compositions obtainable via compounding of the following components”.

For the purposes of the present invention, a phenolic end group is a hydroxy group bonded to an aromatic ring and also optionally capable of existence in deprotonated form. The person skilled in the art is aware that a phenolic end group can also be present in the form of what is known as a phenolate end group by virtue of dissociation of a proton as a consequence of exposure to a base. The term phenolic end groups therefore expressly comprises not only aromatic OH groups but also phenolate groups.

The proportion of phenolic end groups is preferably determined via potentiometric titration. For this, the polymer is dissolved in dimethylformamide, and titrated with a solution of tetrabutylammonium hydroxide in toluene/methanol. The end point is determined by a potentiometric method. The proportion of halogen end groups is preferably determined by means of atomic spectroscopy.

The person skilled in the art can use known methods to determine the average number of phenolic end groups per polymer chain (n^{OH}), on the assumption of strictly linear polymer chains, using the following formula: n^{OH}=m^{OH} [in % by weight]/100*Mₙ^{P} [in g/mol]*1/17, starting from the proportion by weight of phenolic end groups, based on the total weight of the polymer (m^{OH}) and from the number-average molecular weight (Mₙ^{P}).

As an alternative, the average number of phenolic end groups per polymer chain (n^{OH}) can be calculated as follows: n^{OH}=2/(1+(17/35.45*m^{Cl}/m^{OH})) on the assumption that the end groups present are exclusively OH groups and Cl groups, and on the assumption of strictly linear polymer chains, if the proportion by weight of Cl end groups (m^{Cl}) is simultaneously known. The person skilled in the art knows how to adapt the calculation methods in the event that end groups other than Cl are present.

Without any intention of restriction, it is believed that the high content of reactive phenolic end groups in component (A2) causes the latter to act as compatibilizer for components (A) to (D). It is moreover believed that component (A1), which has high content of inert end groups, brings about a further improvement in the property profile of the thermoplastic molding compositions of the invention, the result being that the presence of polyarylene ethers having phenolic end groups on the one hand and of polyarylene ethers having inert end groups on the other hand has a synergistic effect in respect of the final properties of the thermoplastic molding compositions.

Production of polyarylene ethers with simultaneous control of the end groups is known to the person skilled in the art and is described in more detail at a later stage below. The known polyarylene ethers usually have halogen end groups, in particular —F or —Cl, or phenolic OH end groups or phenolate end groups, where the latter can be present as such or in reacted form, in particular in the form of —OCH₃ end groups.

It is preferable that the polyarylene ethers (A1) have at most 0.01% by weight, particularly at most 0.005% by weight, of phenolic end groups, based on the amount by weight of component (A1). It is preferable that the polyarylene ethers (A2) have at least 0.15% by weight, in particular at least 0.18% by weight, and particularly at least 0.2% by weight of phenolic end groups, based on the amount by weight of component (A2), in each case calculated in the form of amount by weight of OH.

In each case, the upper limit for the content of phenolic end groups in components (A1) and, respectively, (A2) is a function of the number of end groups available per molecule (two in the case of linear polyarylene ethers) and of the number-average chain length. The person skilled in the art is aware of corresponding calculations.

It is preferable that the average number of phenolic end groups of component (A1) per polymer chain is from 0 to 0.1, in particular from 0 to 0.08, particularly from 0 to 0.05, and very particularly from 0 to 0.02, and in particular at most 0.01.

It is preferable that the average number of phenolic end groups of component (A2) per polymer chain is from 1.6 to 2, in particular from 1.7 to 2, particularly from 1.8 to 2, and very particularly from 1.9 to 2.

In one particularly preferred embodiment, component (A) is a mixture of from 60 to 99% by weight of polyarylene ether (A1) and from 1 to 40% by weight of polyarylene ether (A2), based in each case on the amount by weight of component (A).

In said preferred embodiment, component (A) is particularly preferably composed of from 70 to 98% by weight, in particular from 80 to 97% by weight, of abovementioned constituent (A1), and of from 2 to 30% by weight, in particular from 3 to 20% by weight, of abovementioned constituent (A2), based in each case on the amount by weight of component (A).

The polyarylene ethers (A1) and (A2) according to the present invention can—except for the end groups—be identical or composed of different units, and/or have different molecular weight, as long as they then retain complete mutual miscibility.

However, it is preferable that the constituents (A1) and (A2) have substantially identical structure, in particular being composed of the same units, and having similar molecular weight, in particular where the number-average molecular weight of one of the components is at most 30% greater than that of the other component.

Polyarylene ethers are a class of polymer known to the person skilled in the art. In principle, any of the polyarylene ethers that are known to the person skilled in the art and/or that can be produced by known methods can be used as constituent of component (A). Corresponding methods are explained at a later stage below.

Preferred polyarylene ethers (A1) and (A2) for the purposes of component (A) are composed independently of one another of units of the general formula I:

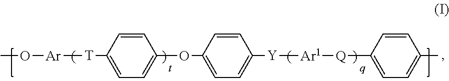

where the definitions of the symbols t, q, Q, T, Y, Ar and Ar¹ are as follows:
t, q: independently of one another 0, 1, 2, or 3,
Q, T, Y: independently of one another in each case a chemical bond or group selected from —O—, —S—, —SO₂—, S═O, C═O, —N═N—, and —CR^{a}R^{b}—, where R^{a} and R^{b} independently of one another are in each case a hydrogen atom or a C₁-C12-alkyl, C₁-C₁₂-alkoxy, or C₆-C₁₈-aryl group, and where at least one of Q, T, and Y is —SO₂—, and
Ar and Ar¹: independently of one another an arylene group having from 6 to 18 carbon atoms.

If, within the abovementioned preconditions, Q, T or Y is a chemical bond, this then means that the adjacent group on the left-hand side and the adjacent group on the right-hand side are present with direct linkage to one another via a chemical bond.

However, it is preferable that Q, T, and Y in formula I are selected independently of one another from —O— and —SO₂—, with the proviso that at least one of the group consisting of Q, T, and Y is —SO₂—.

If Q, T, or Y is —CR^{a}R^{b}—, R^{a} and R^{b} independently of one another are in each case a hydrogen atom or a C₁-C₁₂-alkyl, C₁-C₁₂-alkoxy, or C₆-C₁₈-aryl group.

Preferred C₁-C₁₂-alkyl groups comprise linear and branched, saturated alkyl groups having from 1 to 12 carbon atoms. The following moieties may be mentioned in particular: C₁-C₆-alkyl moiety, e.g. methyl, ethyl, n-propyl, isopropyl, n-butyl, sec-butyl, 2- or 3-methylpentyl, and longer chain moieties, e.g. unbranched heptyl, octyl, nonyl, decyl, undecyl, lauryl, and the singly branched or multibranched analogs thereof.

Alkyl moieties that can be used in the abovementioned C₁-C₁₂-alkoxy groups that can be used are the alkyl groups defined at an earlier stage above having from 1 to 12 carbon atoms. Cycloalkyl moieties that can be used with preference in particular comprise C₃-C₁₂-cycloalkyl moieties, e.g. cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a C₆-C₁₈-arylene group. On the basis of the starting materials described at a later stage below, it is preferable that Ar derives from an electron-rich aromatic substance that is very susceptible to electrophilic attack, preferably selected from the group consisting of hydroquinone, resorcinol, dihydroxynaphthalene, in particular 2,7-dihydroxynaphthalene, and 4,4′-bisphenol. Ar¹ is preferably an unsubstituted C₆- or C₁₂-arylene group.

Particular C₆-C₁₈-arylene groups Ar and Ar¹ that can be used are phenylene groups, e.g. 1,2-, 1,3-, and 1,4-phenylene, naphthylene groups, e.g. 1,6-, 1,7-, 2,6-, and 2,7-naphthylene, and also the arylene groups that derive from anthracene, from phenanthrene, and from naphthacene.

In the preferred embodiment according to formula I, it is preferable that Ar and Ar¹ are selected independently of one another from the group consisting of 1,4-phenylene, 1,3-phenylene, naphthylene, in particular 2,7-dihydroxynaphthylene, and 4,4′-bisphenylene.

Preferred polyarylene ethers (A1) and (A2) for the purposes of component (A) are those which comprise at least one of the following repeat units Ia to Io:

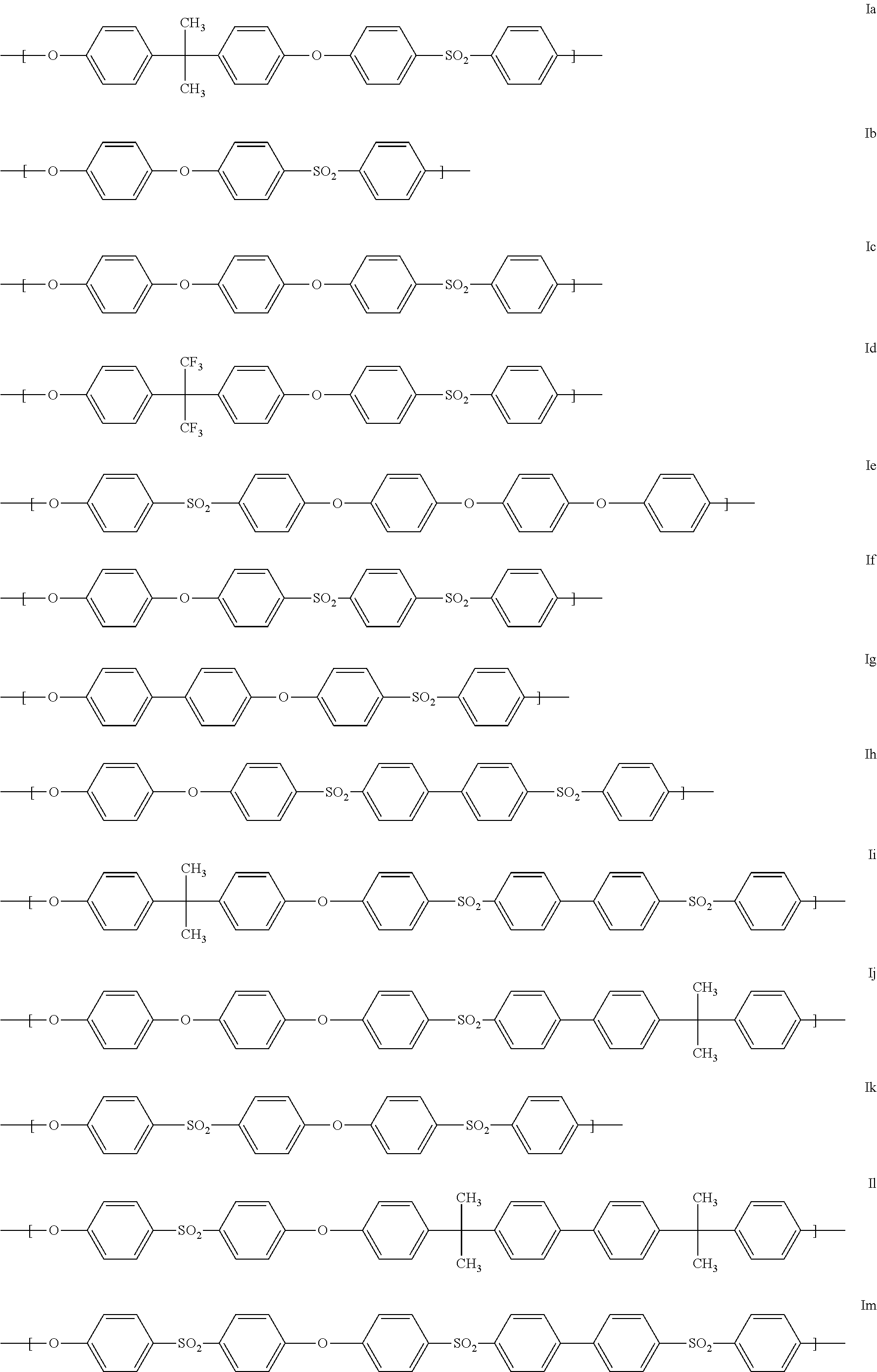

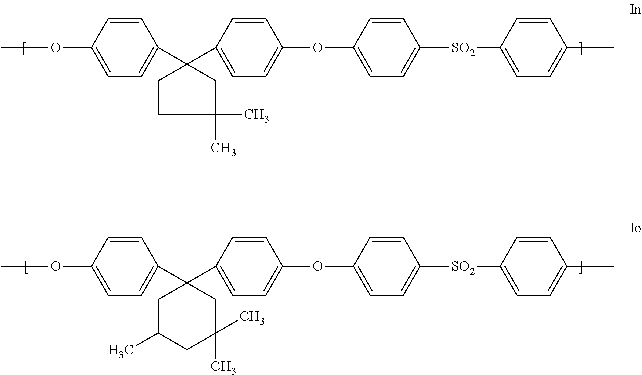

Other preferred units, in addition to the units Ia to Io that are preferably present, are those in which one or more 1,4-phenylene units deriving from hydroquinone have been replaced by 1,3-phenylene units deriving from resorcinol, or by naphthylene units deriving from dihydroxynaphthalene.

Particularly preferred units of the general formula I are the units Ia, Ig, and Ik. It is also particularly preferable that the polyarylene ethers of component (A) are in essence composed of one type of unit of the general formula I, in particular of one unit selected from Ia, Ig, and Ik.

In one particularly preferred embodiment, Ar=1,4-phenylene, t=1, q=0, T is a chemical bond, and Y═SO₂. Particularly preferred polyarylene ether sulfones composed of the abovementioned repeat unit are termed polyphenylene sulfone (PPSU).

In another particularly preferred embodiment, Ar=1,4-phenylene, t=1, q=0, T=C(CH₃)₂, and Y═SO₂. Particularly preferred polyarylene ether sulfones composed of the abovementioned repeat unit are termed polysulfone (PSU).

In another particularly preferred embodiment, Ar=1,4-phenylene, t=1, q=0, T=Y═SO₂. Particularly preferred polyarylene ether sulfones composed of the abovementioned repeat unit are termed polyether sulfone (PESU). This embodiment is very particularly preferred.

For the purposes of the present invention, abbreviations such as PPSU, PESU, and PSU are in accordance with DIN EN ISO 1043-1:2001.

The average molar masses Mₙ (number average) of the preferred polyarylene ethers (A1) and (A2) are generally in the range from 5000 to 60 000 g/mol, with relative viscosities of from 0.20 to 0.95 dl/g. The relative viscosities of the polyarylene ethers are determined in 1% strength by weight N-methylpyrrolidone solution at 25° C. to DIN EN ISO 1628-1.

The weight-average molar masses M_{w} of the polyarylene ethers (A1) and (A2) of the present invention are preferably from 10 000 to 150 000 g/mol, in particular from 15 000 to 120 000 g/mol, particularly preferably from 18 000 to 100 000 g/mol, determined by means of gel permeation chromatography in dimethylacetamide as solvent, against narrowly distributed polymethyl methacrylate as standard.

Production processes that lead to the abovementioned polyarylene ethers are known per se to the person skilled in the art and are described by way of example in Herman F. Mark, “Encyclopedia of Polymer Science and Technology”, third edition, volume 4, 2003, pages 2 to 8, and also in Hans R. Kricheldorf, “Aromatic Polyethers” in: Handbook of Polymer Synthesis, second edition, 2005, pages 427 to 443.

Particular preference is given to the reaction, in aprotic polar solvents and in the presence of anhydrous alkali metal carbonate, in particular sodium carbonate, potassium carbonate, calcium carbonate, or a mixture thereof, very particularly preferably potassium carbonate, between at least one aromatic compound having two halogen substituents and at least one aromatic compound having two functional groups reactive toward abovementioned halogen substituents. One particularly suitable combination is N-methylpyrrolidone as solvent and potassium carbonate as base.

It is preferable that the polyarylene ethers (A1) have either halogen end groups, in particular chlorine end groups, or etherified end groups, in particular alkyl ether end groups, these being obtainable via reaction of the OH or, respectively, phenolate end groups with suitable etherifying agents.

Examples of suitable etherifying agents are monofunctional alkyl or aryl halide, e.g. C₁-C₆-alkyl chloride, C₁-C₆-alkyl bromide, or C₁-C₆-alkyl iodide, preferably methyl chloride, or benzyl chloride, benzyl bromide, or benzyl iodide, or a mixture thereof. For the purposes of the polyarylene ethers of component (A1) preferred end groups are halogen, in particular chlorine, alkoxy, in particular methoxy, aryloxy, in particular phenoxy, or benzyloxy.

Production of the polyarylene ethers (A2) is discussed below. A preferred process for producing polyarylene ethers of component (A2) is described hereinafter and comprises the following steps in the sequence a-b-c:
(a) provision of at least one polyarylene ether (A2*) in the presence of a solvent (S), where the content of phenolic end groups in this polyarylene ether is appropriate for the desired component (A2), where the phenolic end groups thereof are present in the form of phenolate end groups, and this polyarylene ether is preferably composed of units of the general formula I as defined above,
(b) addition of at least one acid, preferably of at least one polybasic carboxylic acid, and
(c) obtaining the polyarylene ethers of component (A2) in the form of solid.

The polyarylene ether (A2*) is preferably provided here in the form of a solution in the solvent (S).

There are in principle various ways of providing the polyarylene ethers (A2*) described. By way of example, an appropriate polyarylene ether (A2*) can be brought directly into contact with a suitable solvent and directly used in the process of the invention, i.e. without further reaction. As an alternative, prepolymers of polyarylene ethers can be used and reacted in the presence of a solvent, whereupon the polyarylene ethers (A2*) described are produced in the presence of the solvent.

However, the polyarylene ether(s) (A2*) is/are preferably provided in step (a) via reaction of at least one starting compound of structure X—Ar—Y (s1) with at least one starting compound of structure HO—Ar¹—OH (s2) in the presence of a solvent (S) and of a base (B), where
Y is a halogen atom,
X is selected from halogen atoms and OH, and
Ar and Ar¹ independently of one another are an arylene group having from 6 to 18 carbon atoms.

The ratio of (s1) and (s2) here is selected in such a way as to produce the desired content of phenolic end groups. Suitable starting compounds are known to the person skilled in the art or can be produced by known methods.

Hydroquinone, resorcinol, dihydroxynaphthalene, in particular 2,7-dihydroxynaphthalene, 4,4′-dihydroxydiphenyl sulfone, bisphenol A, and 4,4′-dihydroxybiphenyl are particularly preferred as starting compound (s2).

However, it is also possible to use trifunctional compounds. In this case, branched structures are produced. If a trifunctional starting compound (s2) is used, preference is given to 1,1,1-tris(4-hydroxyphenyl)ethane.

The quantitative proportions to be used are in principle a function of the stoichiometry of the polycondensation reaction that proceeds, with cleavage of the theoretical amount of hydrogen chloride, and the person skilled in the art adjusts these in a known manner. However, an excess of (s2) is preferable, in order to increase the number of phenolic OH end groups.

In this embodiment, the molar (s2)/(s1) ratio is particularly preferably from 1.005 to 1.2, in particular from 1.01 to 1.15, and very particularly preferably from 1.02 to 1.1.

As an alternative, it is also possible to use a starting compound (s1) having X=halogen and Y=OH. In this case, an excess of hydroxy groups is achieved via addition of the starting compound (s2). In this case, the ratio of the phenolic end groups used to halogen is preferably from 1.01 to 1.2, in particular from 1.03 to 1.15, and very particularly preferably from 1.05 to 1.1.

It is preferable that the conversion in the polycondensation reaction is at least 0.9, so as to provide an adequately high molecular weight. If a prepolymer is used as precursor of the polyarylene ether, the degree of polymerization is based on the number of actual monomers.

Preferred solvents (S) are aprotic polar solvents. The boiling point of suitable solvents is moreover in the range from 80 to 320° C., in particular from 100 to 280° C., preferably from 150 to 250° C. Examples of suitable aprotic polar solvents are high-boiling ethers, esters, ketones, asymmetrically halogenated hydrocarbons, anisole, dimethylformamide, dimethyl sulfoxide, sulfolan, N-ethyl-2-pyrrolidone, and N-methyl-2-pyrrolidone.

The reaction of the starting compounds (s1) and (s2) preferably takes place in the abovementioned aprotic polar solvents (S), in particular N-methyl-2-pyrrolidone.

The person skilled in the art knows per se that the reaction of the phenolic OH groups preferably takes place in the presence of a base (B), in order to increase reactivity with respect to the halogen substituents of the starting compound (s1).

It is preferable that the bases (B) are anhydrous. Particularly suitable bases are anhydrous alkali metal carbonate, preferably sodium carbonate, potassium carbonate, calcium carbonate, or a mixture thereof, and very particular preference is given here to potassium carbonate.

A particularly preferred combination is N-methyl-2-pyrrolidone as solvent (S) and potassium carbonate as base (B).

The reaction of the suitable starting compounds (s1) and (s2) is carried out at a temperature of from 80 to 250° C., preferably from 100 to 220° C., and the boiling point of the solvent provides an upper restriction on the temperature here. The reaction preferably takes place within a period of from 2 to 12 h, in particular from 3 to 8 h.

It has proven advantageous, after step (a) and prior to conduct of step (b), to filter the polymer solution. This removes the salt formed during the polycondensation reaction, and also any gel that may have formed.

It has also proven advantageous for the purposes of step (a) to adjust the amount of the polyarylene ether (A2*), based on the total weight of the mixture of polyarylene ether (A2*) and solvent (S) to from 10 to 70% by weight, preferably from 15 to 50% by weight.

For the purposes of step (b), at least one acid is added, preferably at least one polybasic carboxylic acid, to the polyarylene ether (A2*) from step (a), preferably to the solution of the polyarylene ether (A2*) in the solvent (S).

“Polybasic” means a basicity of at least 2. The basicity is the (optionally average) number of COOH groups per molecule. Polybasic means basicity of two or higher.

For the purposes of the present invention, preferred carboxylic acids are dibasic and tribasic carboxylic acids.

The polybasic carboxylic acid can be added in various ways, in particular in solid or liquid form or in the form of a solution, preferably in a solvent miscible with the solvent (S).

The number-average molar mass of the polybasic carboxylic acid is preferably at most 1500 g/mol, in particular at most 1200 g/mol. At the same time, the number-average molar mass of the polybasic carboxylic acid is preferably at least 90 g/mol.

Particularly suitable polybasic carboxylic acids are those according to the general structure II:

HOOC—R—COOH (II),

where R represents a hydrocarbon moiety having from 2 to 20 carbon atoms and optionally comprising further functional groups, preferably selected from OH and COOH.

Preferred polybasic carboxylic acids are C₄-C₁₀ dicarboxylic acids, in particular succinic acid, glutaric acid, adipic acid, and tricarboxylic acids, in particular citric acid. Particularly preferred polybasic carboxylic acids are succinic acid and citric acid.

In order to provide adequate conversion of the phenolate end groups to phenolic end groups, it has proven advantageous to adjust the amount of the polybasic carboxylic acid(s) used in respect of the amount of the phenolate end groups.

For the purposes of step (b) it is preferable to add a polybasic carboxylic acid so that the amount of carboxy groups is from 25 to 200 mol %, preferably from 50 to 150 mol %, particularly preferably from 75 to 125 mol %, based on the molar amount of phenolic end groups.

If the amount of acid added is too small, the precipitation properties of the polymer solution are inadequate, while any markedly excessive addition can cause discoloration of the product during further processing.

For the purposes of step (c), the polyarylene ether (A2) is obtained in the form of solid. In principle, various processes can be used for obtaining the material in the form of solid. However, it is preferable to obtain the polymer composition via precipitation.

The preferred precipitation process can in particular take place via mixing of the solvent (S) with a poor solvent (S′). A poor solvent is a solvent in which the polymer composition is not soluble. This poor solvent is preferably a mixture of a non-solvent and a solvent. A preferred non-solvent is water. A preferred mixture (S′) of a solvent with a non-solvent is preferably a mixture of the solvent (S), in particular N-methyl-4-pyrrolidone, and water. It is preferable that the polymer solution from step (b) is added to the poor solvent (S′), the result being precipitation of the polymer composition. It is preferable here to use an excess of the poor solvent. It is particularly preferable that the polymer solution from step (a) is added in finely dispersed form, in particular in droplet form.

If the poor solvent (S′) used comprises a mixture of the solvent (S), in particular N-methyl-2-pyrrolidone, and of a non-solvent, in particular water, a preferred solvent:non-solvent mixing ratio is then from 1:2 to 1:100, in particular from 1:3 to 1:50.

A mixture of water and N-methyl-2-pyrrolidone (NMP) in combination with N-methyl-2-pyrrolidone as solvent (S) is preferred as poor solvent (S′). An NMP/water mixture in the ratio of from 1:3 to 1:50, in particular 1:30, is particularly preferred as poor solvent (S′).

The precipitation process is particularly efficient when the content of the polymer composition in the solvent (S), based on the total weight of the mixture of polymer composition and solvent (S), is from 10 to 50% by weight, preferably from 15 to 35% by weight.

The potassium content of component (A2) is preferably at most 600 ppm. The potassium content is determined by means of atomic spectrometry.

Component B

The molding compositions of the invention comprise, as component (B), at least one polyarylene sulfide. In principle, any of the polyarylene sulfides can be used as component (B).

The amounts of component (B) present in the thermoplastic molding compositions of the invention are preferably from 5 to 65% by weight, particularly preferably from 5 to 45% by weight, in particular from 5 to 30% by weight, very particularly preferably from 10 to 20% by weight, based in each case on the total amount of components (A) to (E).

The polyarylene sulfides of component (B) are preferably composed of from 30 to 100% by weight of repeat units according to the general formula —Ar—S—, where —Ar— is an arylene group having from 6 to 18 carbon atoms.

Preference is given to polyarylene sulfides which comprise, based on the total weight of all repeat units, at least 30% by weight, in particular at least 70% by weight, of repeat units III:

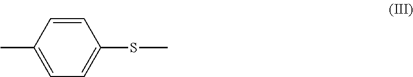

Particularly suitable other repeat units are

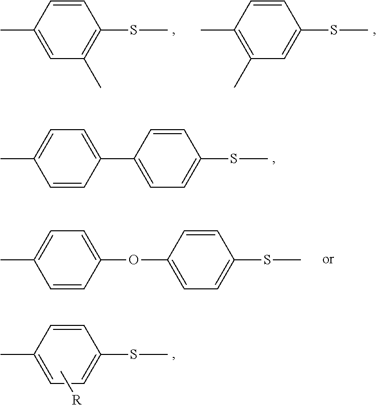

in which R is C₁-C₁₀-alkyl, preferably methyl. The polyarylene sulfides can be homopolymers, random copolymers, or block copolymers, preference being given here to homopolymers (identical repeat units). Very particularly preferred polyarylene sulfides are composed of 100% by weight of repeat units according to the general formula III. Component (B) is therefore particularly preferably a polyphenylene sulfide, in particular poly(1,4-phenylene sulfide).

End groups that can be used in the polyarylene sulfides used according to the invention are in particular halogen, thiol, or hydroxy, preferably halogen.

The polyarylene sulfides of component (B) can be branched or unbranched compounds. The polyarylene sulfides of component (B) are preferably linear, i.e. not branched.

The weight-average molar masses of the polyarylene sulfides of component (B) are preferably from 5000 to 100 000 g/mol.

Polyarylene sulfides of this type are known per se or can be produced by known methods. Appropriate production methods are described by way of example in Hans R. Kricheldorf, “Aromatic Polyethers” in: Handbook of Polymer Synthesis, second edition, 2005, pages 486 to 492.

They can in particular, as described in U.S. Pat. No. 2,513,188, be produced via reaction of haloaromatics with sulfur or with metal sulfides. It is equally possible to heat metal salts of halogen-substituted thiophenols (see GB-B 962 941). Among the preferred syntheses of polyarylene sulfides is the reaction of alkali metal sulfides with haloaromatics in solution, for example as found in U.S. Pat. No. 3,354,129. U.S. Pat. No. 3,699,087 and U.S. Pat. No. 4,645,826 describe further processes.

Component C

In the invention, the thermoplastic molding compositions comprise at least one functionalized polyarylene ether comprising carboxy groups, preferably those with intrinsic viscosity to DIN EN ISO 1628-1 of from 45 to 65 ml/g, measured in 1% strength by weight solution in N-methyl-2-pyrrolidone at 25° C. The intrinsic viscosity to DIN EN ISO 1628-1 of the functionalized polyarylene ethers of component (C), measured in 1% strength by weight solution in N-methyl-2-pyrrolidone at 25° C., is preferably at least 46 ml/g, particularly preferably at least 47 ml/g, in particular at least 48 ml/g.

On the other hand, the use of polyarylene ethers comprising carboxy groups with intrinsic viscosity to DIN EN ISO 1628-1 of more than 65 ml/g, measured in 1% strength by weight solution in N-methyl-2-pyrrolidone at 25° C., leads to a disadvantageous reduction in flowability, without any further improvement in mechanical properties. Accordingly, the intrinsic viscosity to DIN EN ISO 1628-1 of the polyarylene ethers of component (C) is preferably subject to an upper restriction and is preferably at most 65 ml/g, particularly preferably at most 61 ml/g, in particular at most 57 ml/g, measured in each case in 1% strength by weight solution in N-methyl-2-pyrrolidone at 25° C.

Intrinsic viscosity in the stated range in thermoplastic molding compositions based on polyarylene ethers and on polyarylene sulfides comprising particulate or fibrous fillers leads to the improved mechanical properties of the invention, together with good processability. Without any intended restriction, the chemical structure and the defined intrinsic viscosity of the functionalized polyarylene ethers of component (C) are believed to result in synergistic interaction of these with the fillers, in particular glassfibers.

It is preferable that the thermoplastic molding compositions of the invention comprise, as component (C), at least one functionalized polyarylene ether which comprises units of the general formula I as defined above, and also units of the general formula IV:

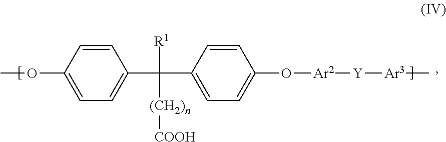

in which
n is 0, 1, 2, 3, 4, 5, or 6;
R¹ is hydrogen, a C₁-C₆-alkyl group, or —(CH₂)ₙ—COOH;
Ar² and Ar³ can be identical or different and are independently of one another a C₆-C₁₈-arylene group, and
Y is a chemical bond or a group selected from —O—, —S—, —SO₂—, S═O, C═O, —N═N—, and —CR^{a}R^{b}—, where R^{a} and R^{b} can be identical or non-identical, and independently of one another are in each case a hydrogen atom or a C₁-C₁₂-alkyl, C₁-C₁₂-alkoxy, or C₆-C₁₈-aryl group.

It is preferable that the proportion of units according to the general formula IV, based on the entirety of the units according to formula I and formula IV, is from 0.5 to 3 mol %, preferably from 0.6 to 2 mol %, with particular preference from 0.7 to 1.5 mol %.

For the purposes of the present invention, the proportion of units according to the general formula IV, based on the entirety of the units according to formula I and formula IV, is in principle determined by means of ¹H NMR spectroscopy, using a defined amount of 1,3,5-trimethoxybenzene as internal standard. The person skilled in the art knows how to convert % by weight to mol %.

For the purposes of the general formula IV, it is preferable that n=2 and that R¹=methyl.

For the purposes of the general formula IV, it is moreover preferable that Ar²═Ar³=1,4-phenylene, and that Y═—SO₂—.

The functionalized polyarylene ethers (component C) used in the molding compositions of the invention are compounds known per se or can be produced by known processes.

By way of example, the functionalized polyarylene ethers of component (C) are obtainable by a method based on EP-A-0 185 237, or else by the processes described by I. W. Parsons et al., in Polymer, 34, 2836 (1993) and T. Koch, H. Ritter, in Macromol. Phys. 195, 1709 (1994).

The polyarylene ethers are accordingly in particular obtainable via polycondensation of compounds of the general formula V:

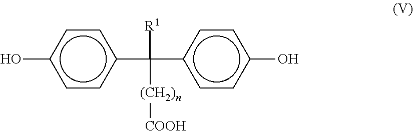

in which R¹ and n are defined as above, with at least one further aromatic compound reactive toward the compounds of the general formula V, a particular example being 4,4′-dichlorodiphenyl sulfone, and optionally with further hydroxy-functionalized compounds, e.g. bisphenol A and/or bisphenol S, and/or 4,4′-dihydroxybiphenyl. Suitable reactants are well known to the person skilled in the art.

It is also in principle possible to use the methods used for polyarylene ethers of component (A) for producing the functionalized polyarylene ethers of component (C), and preference is likewise given here to the solution polymerization process in dipolar aprotic solvents with the action of base.

The statements made in relation to component (A) in respect of preferred structural elements of the general formula I apply correspondingly to the functionalized polyarylene ethers of component (C).

In particular, it is preferable that the polyarylene ethers of components (A) and (C) are structurally similar, in particular being based on the same monomer units, and differing merely in relation to the units of the general formula IV for the purposes of component (C). It is particularly preferable that both component (A) and component (C) are based on units of the PESU type as defined above, or that both component (A) and component (C) are based on components of the PPSU type as defined above, or that both component (A) and component (C) are based on units of the PSU type as defined above. “Are based on” in this context means that both component (A) and component (C) are composed of the same units, differing merely in that component (C) has additional functionalization, preferably comprising monomer units of the general formula IV as defined above. It is particularly preferable that the polyarylene ethers of component (A) and the functionalized polyarylene ethers of component (C) in each case comprise the same units of the general formula I.

For the purposes of the general formula IV, particularly suitable units are:

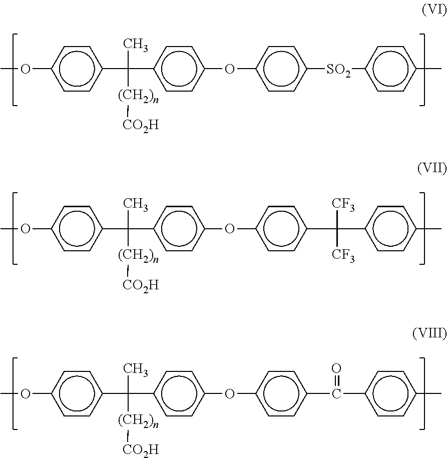

in which n is in each case an integer from 0 to 4. Very particular preference is given to the unit VI.

Component D

The thermoplastic molding compositions of the present invention comprise, as component (D), at least one fibrous or particulate filler, the preferred amount of which is from 5 to 70% by weight, particularly preferably from 15 to 70% by weight, in particular from 15 to 65% by weight, based on a total of 100% by weight of components (A) to (E).

The molding compositions of the invention can in particular comprise particulate or fibrous fillers, particular preference being given to fibrous fillers.

Preferred fibrous fillers are carbon fibers, potassium titanate whiskers, aramid fibers, and particularly preferably glassfibers. If glassfibers are used, these can have been equipped with a size, preferably with a polyurethane size, and with a coupling agent, to improve compatibility with the matrix material. The diameter of the carbon fibers and glassfibers used is generally in the range from 6 to 20 μm. Component (D) is therefore particularly preferably composed of glassfibers.

The form in which glassfibers are incorporated can either be that of short glassfibers or else that of continuous-filament fibers (rovings). The average length of the glassfibers in the finished injection molding is preferably in the range from 0.08 to 0.5 mm.

Carbon fibers or glassfibers can also be used in the form of textiles, mats, or glass-silk rovings.

Suitable particulate fillers are amorphous silica, carbonates, such as magnesium carbonate and chalk, powdered quartz, mica, various silicates, such as clays, muscovite, biotite, suzoite, tin maletite, talc, chlorite, phlogopite, feldspar, calcium silicates, such as wollastonite, or aluminum silicates, such as kaolin, particularly calcined kaolin.

Preferred particulate fillers are those in which at least 95% by weight, preferably at least 98% by weight, of the particles have a diameter (greatest diameter through the geometric center), determined on the finished product, of less than 45 μm, preferably less than 40 μm, where the value known as the aspect ratio of the particles is in the range from 1 to 25, preferably in the range from 2 to 20, determined on the finished product. The aspect ratio is the ratio of particle diameter to thickness (greatest dimension to smallest dimension, in each case through the geometric center).

The particle diameters can by way of example be determined here by recording electron micrographs of thin layers of the polymer mixture and evaluating at least 25 filler particles, preferably at least 50. The particle diameters can also be determined by way of sedimentation analysis, as in Transactions of ASAE, page 491 (1983). Sieve analysis can also be used to measure the proportion by weight of the fillers with diameter less than 40 μm.

The particulate fillers used particularly preferably comprise talc, kaolin, such as calcined kaolin, or wollastonite, or a mixture of two or all of said fillers. Among these, particular preference is given to talc having a proportion of at least 95% by weight of particles with diameter smaller than 40 μm and with aspect ratio of from 1.5 to 25, in each case determined on the finished product. Kaolin preferably has a proportion of at least 95% by weight of particles with diameter smaller than 20 μm and preferably has an aspect ratio of from 1.2 to 20, which in each case is determined on the finished product.

The thermoplastic molding compositions can moreover comprise further additives and/or processing aids as component E.

Component E

The molding compositions of the invention can comprise, as constituents of component (E), auxiliaries, in particular processing aids, pigments, stabilizers, flame retardants, or a mixture of various additives. Other examples of conventional additives are oxidation retarders, agents to counteract decomposition by heat and decomposition by ultraviolet light, lubricants and mold-release agents, dyes and plasticizers.

The proportion of component (E) in the molding composition of the invention is in particular from 0 up to 30% by weight, preferably from 0 up to 20% by weight, in particular from 0 to 15% by weight, based on the total weight of components (A) to (E). If component E includes stabilizers, the proportion of said stabilizers is usually up to 2% by weight, preferably from 0.01 to 1% by weight, in particular from 0.01 to 0.5% by weight, based on the total of the % by weight values for components (A) to (E).

The amounts generally comprised of pigments and dyes are from 0 to 6% by weight, preferably from 0.05 to 5% by weight, and in particular from 0.1 to 3% by weight, based on the total of the % by weight values for components (A) to (E).

Pigments for the coloring of thermoplastics are well known, see for example R. Gächter and H. Müller, Taschenbuch der Kunststoffadditive [Plastics additives handbook], Carl Hanser Verlag, 1983, pages 494 to 510. A first preferred group of pigments that may be mentioned are white pigments, such as zinc oxide, zinc sulfide, white lead [2 PbCO₃.Pb(OH)₂], lithopones, antimony white, and titanium dioxide. Of the two most familiar crystalline forms of titanium dioxide (rutile and anatase), it is in particular the rutile form which is used for white coloring of the molding compositions of the invention. Black color pigments which can be used according to the invention are iron oxide black (Fe₃O₄), spinel black [Cu(Cr, Fe)₂O₄], manganese black (a mixture composed of manganese dioxide, silicon dioxide, and iron oxide), cobalt black, and antimony black, and also particularly preferably carbon black, which is mostly used in the form of furnace black or gas black. In this connection see G. Benzing, Pigmente für Anstrichmittel [Pigments for paints], Expert-Verlag (1988), pages 78 ff.

Particular color shades can be achieved by using inorganic chromatic pigments, such as chromium oxide green, or organic chromatic pigments, such as azo pigments or phthalocyanines. Pigments of this type are known to the person skilled in the art.

Examples of oxidation retarders and heat stabilizers which can be added to the thermoplastic molding compositions according to the invention are halides of metals of group I of the Periodic Table of the Elements, e.g. sodium halides, potassium halides, or lithium halides, examples being chlorides, bromides, or iodides. Zinc fluoride and zinc chloride can moreover be used. It is also possible to use sterically hindered phenols, hydroquinones, substituted representatives of said group, secondary aromatic amines, optionally in combination with phosphorus-containing acids, or to use their salts, or a mixture of said compounds, preferably in concentrations up to 1% by weight, based on the total of the % by weight values for components (A) to (E).

Examples of UV stabilizers are various substituted resorcinols, salicylates, benzotriazoles, and benzophenones, the amounts generally used of these being up to 2% by weight.

Lubricants and mold-release agents, the amounts of which added are generally up to 1% by weight, based on the total of the % by weight values for components (A) to (E), are stearyl alcohol, alkyl stearates, and stearamides, and also esters of pentaerythritol with long-chain fatty acids. It is also possible to use dialkyl ketones, such as distearyl ketone.

The molding compositions of the invention comprise, as preferred constituent, from 0.1 to 2% by weight, preferably from 0.1 to 1.75% by weight, particularly preferably from 0.1 to 1.5% by weight, and in particular from 0.1 to 0.9% by weight (based on the total of the % by weight values for components (A) to (E)) of stearic acid and/or stearates. Other stearic acid derivatives can in principle also be used, examples being esters of stearic acid.

Stearic acid is preferably produced via hydrolysis of fats. The products thus obtained are usually mixtures composed of stearic acid and palmitic acid. These products therefore have a wide softening range, for example from 50 to 70° C., as a function of the constitution of the product. Preference is given to products with more than 20% by weight content of stearic acid, particularly preferably more than 25% by weight. It is also possible to use pure stearic acid (>98%).

Component (E) can moreover also include stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is preferable to use aluminum tristearate.

Further additives that can be used are also those known as nucleating agents, an example being talc.

Components (A) to (E) can be mixed in any desired sequence.

The molding compositions of the invention can be produced by processes known per se, for example extrusion. The molding compositions of the invention can by way of example be produced by mixing the starting components in conventional mixing apparatuses, such as screw-based extruders, preferably twin-screw extruders, Brabender mixers, or Banbury mixers, or else kneaders, and then extruding them. The extrudate is cooled and comminuted. The sequence of the mixing of the components can be varied, and it is therefore possible to mix two or more than two components in advance, but it is also possible to mix all of the components together.

In order to obtain a mixture with maximum homogeneity, intensive and thorough mixing is advantageous. Average mixing times needed for this are generally from 0.2 to 30 minutes at temperatures of from 290 to 380° C., preferably from 300 to 370° C. The extrudate is generally cooled and comminuted.

The thermoplastic molding compositions of the invention can be used advantageously for producing moldings, fibers, foams, or films. The molding compositions of the invention are particularly suitable for producing moldings for household items, or for electrical or electronic components, as well as for producing moldings for the vehicle sector, and in particular automobiles.

The examples below provide further explanation of the invention without restricting the same.

### EXAMPLES

The moduli of elasticity, ultimate tensile strength, and tensile strain at break of the specimens were determined on dumbbell specimens in the ISO 527 tensile test.

The impact resistance of the products was determined on ISO specimens to ISO 179 1 eU.

Flowability was assessed on the basis of melt viscosity. Melt stability was determined by means of a capillary rheometer. Apparent viscosity at 350° C. was determined here as a function of shear rate in a capillary viscometer (Gottfert Rheograph 2003 capillary viscometer) using a circular capillary of length 30 mm and radius 0.5 mm, an inlet angle of 180° for the nozzle, a diameter of 12 mm for the melt reservoir vessel, and a preheating time of 5 minutes. The values stated were determined at 1000 Hz.

Resistance to FAM B was determined by placing ISO specimens of dimensions 80×40×4 mm in FAM B at 60° C. for 7 days. The specimens were then allowed to dry in air, and then placed in vacuo at room temperature for 1 day and then in vacuo at 100° C. for 2 days. Impact resistance to ISO 179 1 eU was then determined.

The intrinsic viscosity of the polyarylene ethers was determined in 1% strength N-methylpyrrolidone solution at 25° C. to DIN EN ISO 1628-1.

Component A1

A polyether sulfone of PESU type with intrinsic viscosity of 49.0 ml/g (Ultrason® E 1010 from BASF SE) was used as component A1-1. The product used had 0.16% by weight of Cl end groups and 0.21% by weight of OCH₃ end groups.

Component A2

A polyether sulfone with intrinsic viscosity of 55.6 ml/g was used as component A2-1, and had 0.20% by weight of OH end groups and 0.02% by weight of Cl end groups.

Component B

A polyphenylene sulfide with melt viscosity of 145 Pa*s at 330° C. and shear rate 1000 Hz was used as component B-1.

Component C

A functionalized polyether sulfone was used as component C-1, and was produced as follows: 577.03 g of dichlorodiphenyl sulfone, 495.34 g of dihydroxydiphenyl sulfone, and 5.73 g of 4,4′-bishydroxyphenylvaleric acid (“DPA”) were dissolved in 1053 ml of NMP under nitrogen, and 297.15 g of anhydrous potassium carbonate were admixed. The reaction mixture was heated to 190° C. and kept at this temperature for 6 h. The mixture was then diluted with 1947 ml of NMP. After cooling to T<80° C., the suspension was discharged. Filtration was then used to remove the insoluble constituents. The resultant solution was then precipitated in water. The resultant white powder was then repeatedly extracted with hot water and then dried in vacuo at 140° C. The proportion of DPA units was determined by means of ¹H NMR spectroscopy using 1,3,5-trimethoxybenzene as internal standard as 0.9 mol %, and the intrinsic viscosity of the product was 46.9 ml/g.

Component D

Chopped glassfibers with staple length 4.5 mm and fiber diameter 10 μm were used as component D-1, and had been provided with a polyurethane size.

TABLE 1
Properties of the blends of polyarylene ethers and polyarylene sulfides.
The constitution of the thermoplastic molding compositions has been stated in
parts by weight.

Example

| | comp 1 | comp 2 | comp 3 | comp 4 | 5 | 6 | comp 7 | 8 |
|---|---|---|---|---|---|---|---|---|
| Component | 70 | 41 | 36 | 36 | 34 | 31 | 36 | 28.5 |
| A1-1 | | | | | | | | |
| Component | — | — | — | 5 | 2 | 5 | — | 2.5 |
| A2-1 | | | | | | | | |
| Component B-1 | — | 14 | 14 | 14 | 14 | 14 | 19 | 19 |
| Component C-1 | — | — | 5 | — | 5 | 5 | — | 5 |
| Component D-1 | 30 | 45 | 45 | 45 | 45 | 45 | 45 | 45 |
| Modulus of | 9.40 | 16.5 | 16.4 | 16.5 | 16.4 | 16.3 | 17.1 | 17.2 |
| elasticity [GPa] | | | | | | | | |
| Tensile strain | 2.3 | 1.4 | 1.9 | 1.5 | 1.9 | 1.9 | 1.3 | 1.7 |
| at break [%] | | | | | | | | |
| Ultimate tensile | 134 | 148 | 161 | 152 | 166 | 169 | 156 | 175 |
| strength [MPa] | | | | | | | | |
| ISO 179 1eU | 47 | 42 | 53 | 44 | 57 | 59 | 37 | 49 |
| [kJ/m²] | | | | | | | | |
| Viscosity at | 684 | 552 | 561 | 562 | 560 | 557 | 479 | 488 |
| 1000 Hz | | | | | | | | |
| (350° C.) | | | | | | | | |
| Loss of mass in | 2.1 | 0.9 | 0.7 | 0.8 | 0.3 | 0.2 | 0.7 | 0.1 |
| FAM B [%] | | | | | | | | |

The molding compositions of the invention feature improved resistance to FAM B together with good mechanical properties. The molding compositions of the invention in particular have high tensile strain at break and high impact resistance, and also improved ultimate tensile strength.

1-18. (canceled)

19. A thermoplastic molding composition comprising the following components:
(A) at least one polyarylene ether (A1) having an average of at most 0.1 phenolic end group per polymer chain and at least one polyarylene ether (A2) having an average of at least 1.5 phenolic end groups per polymer chain,
(B) at least one polyarylene sulfide,
(C) at least one functionalized polyarylene ether comprising carboxy groups,
(D) at least one fibrous or particulate filler, and
(E) optionally further additives and/or processing aids.

20. The thermoplastic molding composition according to claim 19, where the polyarylene ethers (A1) have an average of at most 0.05 phenolic end group per polymer chain.

21. The thermoplastic molding composition according to claim 19, where the polyarylene ethers (A2) have an average of at least 1.8 phenolic end groups per polymer chain.

22. The thermoplastic molding composition according to claim 19, comprising from 20 to 88.5% by weight of component (A1), from 0.5 to 10% by weight of component (A2), from 5 to 65% by weight of component (B), from 1 to 15% by weight of component (C), from 5 to 70% by weight of component (D), and from 0 to 40% by weight of component (E), where the total of the % by weight values for components (A) to (E), based on the total amount of components (A) to (E), is 100% by weight.

23. The thermoplastic molding composition according to claim 19, where the polyarylene ethers of components (A1) and (A2) are composed independently of one another of units of the general formula I: 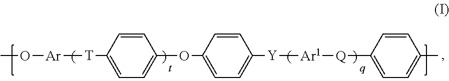
where the definitions are as follows:
t, q: independently of one another 0, 1, 2, or 3,
Q, T, Y: independently of one another in each case a chemical bond or group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group, where at least one of Q, T, and Y is not —O—, and at least one of Q, T, and Y is —SO₂—, and
Ar and Ar¹: independently of one another a C₆-C₁₈-arylene group.

24. The thermoplastic molding composition according to claim 23, where the polyarylene ethers (A1) and (A2) are composed of the same units according to the general formula I.

25. The thermoplastic molding composition according to claim 23, where Q, T, and Y in formula (I) have been selected independently of one another from —O— and —SO₂—, and at least one of Q, T, and Y is —SO₂—.

26. The thermoplastic molding composition according to claim 23, where Ar and Ar¹ in formula (I) have been selected independently of one another from the group consisting of 1,4-phenylene, 1,3-phenylene, naphthylene, and 4,4′-bisphenylene.

27. The thermoplastic molding composition according claim 19, where the functionalized polyarylene ether comprising carboxy groups comprises units of the general formula I as defined in claim 23, and also units of the general formula IV: 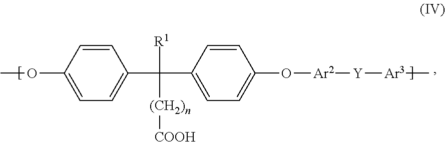
in which
n is an integer from 0 to 6, and
R¹ is H, C₁ to C₆-alkyl, or —(CH₂)ₙ—COOH
Ar² and Ar³ independently of one another are a C₆-C₁₈-arylene group, and
Y is a chemical bond or a group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group.

28. The thermoplastic molding composition according to claim 27, where the proportion of units according to the general formula (I), based on the entirety of the units according to formula (I) and formula (IV), is from 0.5 to 2 mol %, preferably from 0.7 to 1.5 mol %.

29. The thermoplastic molding composition according to claim 27, where n=2 and R¹=methyl.

30. The thermoplastic molding composition according to claim 27, where Ar²═Ar³═1,4-phenylene, and Y═—SO₂—.

31. The thermoplastic molding composition according to claim 19, where the polyarylene sulfides of component (B) are composed of from 30 to 100% by weight of repeat units according to the general formula —Ar—S—, where —Ar— is an arylene group having from 6 to 18 carbon atoms.

32. The thermoplastic molding composition according to claim 19, where component (B) is polyphenylene sulfide, preferably poly(1,4-phenylene sulfide).

33. The thermoplastic molding composition according to claim 19, where component (D) is composed of glassfibers.

34. A process for producing thermoplastic molding compositions according to claim 19 comprising the mixing of components (A) to (E) in a mixing apparatus.

35. The use of thermoplastic molding compositions according to claim 19 for producing moldings, fibers, foams, or films.

36. A molding, fiber, foam, or film comprising thermoplastic molding compositions according to claim 19.
